(19) United States
(12) Patent Application Publication
(10) Pub. No.: US 2024/0265417 A1
(43) Pub. Date: Aug. 8, 2024

(54) INDOOR POSITION INFORMATION STORAGE PROCESSING SYSTEM, INDOOR POSITION INFORMATION DETECTION SYSTEM, ELECTRIC POWER APPARATUS, INDOOR POSITION INFORMATION PROCESSING DEVICE, INDOOR POSITION INFORMATION PROCESSING METHOD, AND NON-TRANSITORY COMPUTER-READABLE STORAGE MEDIUM

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Tomoyuki HOTTA, Tokyo (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 18/641,551

(22) Filed: Apr. 22, 2024

Related U.S. Application Data
(63) Continuation of application No. PCT/JP2022/041143, filed on Nov. 4, 2022.

(30) Foreign Application Priority Data
Nov. 10, 2021 (JP) 2021-183458

(51) Int. Cl. G06Q 30/0204; G01S 5/14

(52) U.S. Cl. CPC G06Q 30/0205; G01S 5/14; G01S 2205/02

(57) ABSTRACT

An indoor position information storage processing system of an embodiment includes an electric power apparatus, a first transmitter, a first receiver, a position detector, and a first information processing device. The first information processing device processes information based on the distance-measurement waves and a position of the first receiver. The first distance calculation unit calculates a distance between the first transmitter and the first receiver on the basis of distance-measurement waves received by the first receiver. The first position calculation unit calculates a position of the first transmitter on the basis of the calculated distance and a position of the first receiver. The first storage processing unit stores the calculated position of the first transmitter in a storage unit as a position of the electric power apparatus.

### CROSS-REFERENCE TO RELATED APPLICATION

This application is based upon and claims the benefit of priority from Japanese Patent Application No. 2021-183458, filed Nov. 10, 2021, the entire contents of which are incorporated herein by reference.

### FIELD

Embodiments of the present invention relate to an indoor position information storage processing system, an indoor position information detection system, an electric power apparatus, an indoor position information processing device, an indoor position information processing method, and a non-transitory computer-readable storage medium.

### BACKGROUND

In recent years, there has been an increasing need for position information marketing for the purpose of acquiring new customers and increasing the amount spent per customer in the retail industry. For the position information marketing, for example, position information of customers moving within a shop is acquired. For this reason, beacon equipment and power supplies used to collect position information are required within the shop, but it may not be easy to ensure the equipment of these facilities. As a result, position information marketing may become difficult to use.

### BRIEF DESCRIPTION OF THE DRAWINGS

FIG. 1 is a diagram which shows an example of an indoor position information processing system 1 according to a first embodiment.

FIG. 2 is a cross-sectional view of a building M that serves as a commercial facility.

FIG. 3 is a diagram which shows a state in which an inside of a room of the building M is looked up at from indoors.

FIG. 4 is a diagram which schematically shows a commercial facility SP in which the indoor position information processing system 1 is provided.

FIG. 5 is a diagram which shows an example of a hardware configuration of illumination equipment 10 and first transmitter 20.

FIG. 6 is a diagram which shows an example of a hardware configuration of a shop terminal 30 of the first embodiment.

FIG. 7 is a diagram which shows an example of a hardware configuration of a customer terminal 40 of the first embodiment.

FIG. 8 is a diagram which shows an example of a hardware configuration of a management device 100 of the first embodiment.

FIG. 9 is a diagram which shows an example of a functional configuration of the shop terminal 30 of the first embodiment.

FIG. 10 is a diagram which shows an example of a functional configuration of the customer terminal 40 of the first embodiment.

FIG. 11 is a diagram which shows an example of a functional configuration of the management device 100 of the first embodiment.

FIG. 12 is a diagram which shows a position of the illumination equipment 10 associated with a transmitter ID.

FIG. 13 is a sequence diagram which shows an example of processing in the indoor position information processing system 1 during an illumination installation.

FIG. 14 is a sequence diagram which shows an example of processing in the indoor position information processing system 1 during shop business hours.

FIG. 15 is a diagram which shows an example of an indoor position information processing system 2 of a second embodiment.

FIG. 16 is a diagram which shows an example of a hardware configuration of a shop terminal 50 of the second embodiment.

FIG. 17 is a diagram which shows an example of a hardware configuration of a customer terminal 60 according to the second embodiment.

FIG. 18 is a diagram which shows an example of a hardware configuration of illumination equipment 10 and a transmission wave information processing device 70 of the second embodiment.

FIG. 19 is a diagram which shows an example of a functional configuration of a management device 200 of the second embodiment.

FIG. 20 is a cross-sectional view of an interior of a building M in which a first mobile object 80 travels.

### DETAILED DESCRIPTION

According to one embodiment, an indoor position information storage processing system includes an electric power apparatus, a first transmitter, a first receiver, a position detector, and a first information processing device. The electric power apparatus is provided in a building. The first transmitter is attached to the electric power apparatus and is configured to transmit distance-measurement waves. The first receiver is configured to receive the distance-measurement waves transmitted by the first transmitter. The position detector is configured to detect a position of the first receiver. The first information processing device is configured to process information based on the distance-measurement waves and the position of the first receiver. The first information processing device includes a first distance calculation unit, a first position calculation unit, and a first storage processing unit. The first distance calculation unit is configured to calculate a distance between the first transmitter and the first receiver on the basis of distance-measurement waves received by the first receiver. The first position calculation unit is configured to calculate a position of the first transmitter on the basis of the calculated distance and the position of the first receiver. The first storage processing unit is configured to store the calculated position of the first transmitter in a storage unit as a position of the electric power apparatus.

Hereinafter, an indoor position information storage processing system, an indoor position information detection system, an electric power apparatus, an indoor position information processing device, an indoor position information processing method, and a non-transitory computer-readable storage medium of embodiments will be described with reference to the drawings.

### First Embodiment

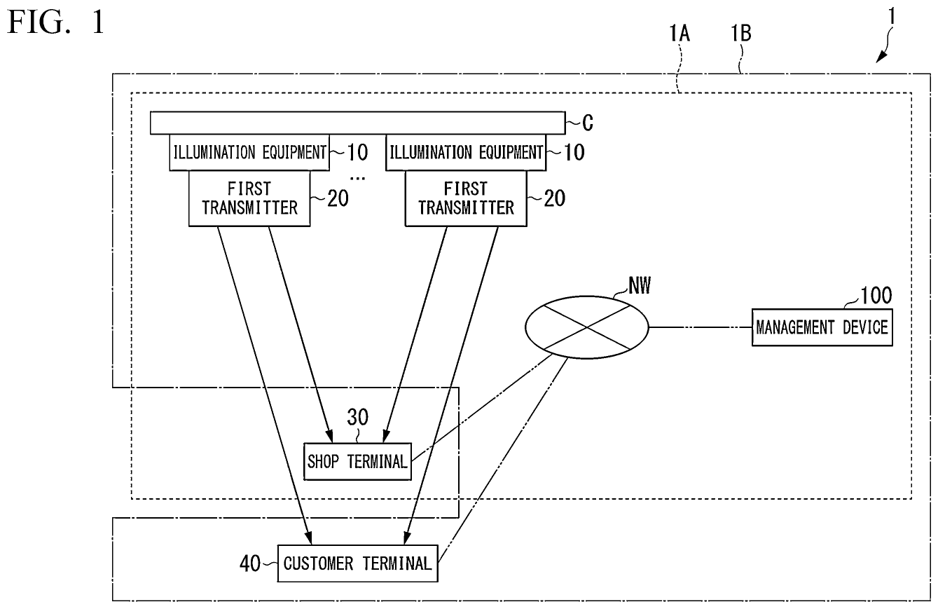

First, an overall configuration of an indoor position information processing system 1 of a first embodiment will be described. FIG. 1 is a diagram which shows an example of the indoor position information processing system 1 according to the first embodiment. The indoor position information processing system 1 includes, for example, a plurality of pieces of illumination equipment 10, a plurality of first transmitters 20, a shop terminal 30, a customer terminal 40, and a management device 100.

The plurality of pieces of illumination equipment 10 are installed, for example, on a ceiling C in a building serving as a commercial facility. The first transmitters 20 are embedded in and attached to the plurality of pieces of illumination equipment 10 on an indoor side of the building. The first transmitter 20 may be attached externally to the illumination equipment 10.

The shop terminal 30 and the management device 100, and the customer terminal 40 and the management device 100, are connected to each other by a network NW to be able to communicate with each other. The network NW may be an intranet, a local area network (LAN), a wireless LAN, or the like, and it is preferable that information security of a certain level or higher be implemented.

The indoor position information processing system 1 is used when an illumination is installed in a shop (hereinafter referred to as during an illumination installation) and when a position of a customer is detected while the shop is open (hereinafter referred to as during shop business hours). The indoor position information processing system 1 functions as an indoor position information storage processing system 1A including the plurality of pieces of illumination equipment 10, the first transmitters 20, the shop terminal 30, and the management device 100 during an illumination installation. The indoor position information processing system 1 functions as an indoor position information detection system 1B including the plurality of pieces of illumination equipment 10, the first transmitters 20, the customer terminal 40, and the management device 100 during shop business hours. The management device 100 is an example of a first information processing device and a third information processing device.

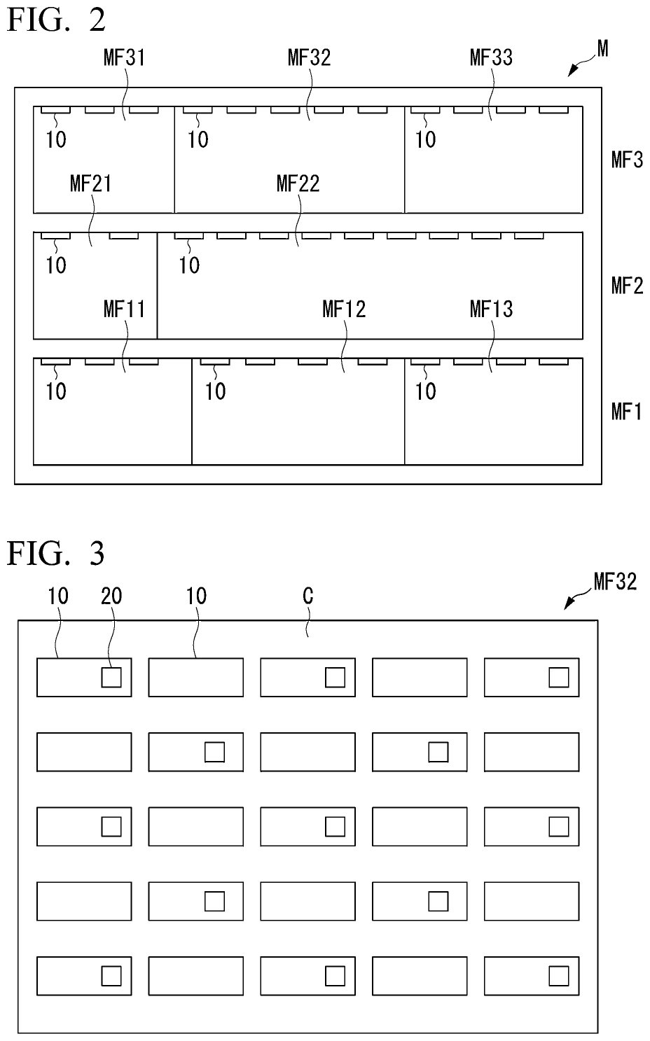

FIG. 2 is a cross-sectional view of a building M serving as a commercial facility. The building M is a three-story building with a plurality of floors, for example, a first floor MF1, a second floor MF2, and a third floor MF3. The building M may have one story, two stories, or four stories or more. The first floor MF1, the second floor MF2, and the third floor MF3 in the building M are all partitioned into small rooms. The first floor MF1 is provided with a first floor first room MF11, a first floor second room MF12, and a first floor third room MF13. The second floor MF2 is provided with a second floor first room MF21 and a second floor second room MF22. The third floor MF3 is provided with a third floor first room MF31, a third floor second room MF32, and a third floor third room MF33. The floors do not need to be partitioned into small rooms.

The plurality of pieces of illumination equipment 10 are provided in each room on each floor. FIG. 3 is a diagram which shows a state in which an inside of a room of the building M is looked up at. FIG. 3 shows a state in which the third floor second room MF32 is looked up at from indoors. 25 (5×5) pieces of illumination equipment 10 are installed in a ceiling C of the third floor second room MF32. Among the 25 pieces of illumination equipment, 13 pieces of illumination equipment are equipped with the first transmitter 20. Among the pieces of illumination equipment 10 included in five columns of illumination equipment (hereinafter referred to as illumination equipment columns), those with the embedded first transmitter 20 and those without the embedded first transmitter 20 are arranged alternately.

Among these, the first transmitters 20 are embedded in three pieces of illumination equipment 10 in each of the first, third, and fifth illumination equipment columns, and the first transmitters 20 are embedded in two pieces of illumination equipment 10 in each of the second and fourth illumination equipment columns. For this reason, when the third floor second room MF32 is viewed from above, the plurality of pieces of illumination equipment 10 embedded with the first transmitter 20 are arranged in a staggered manner.

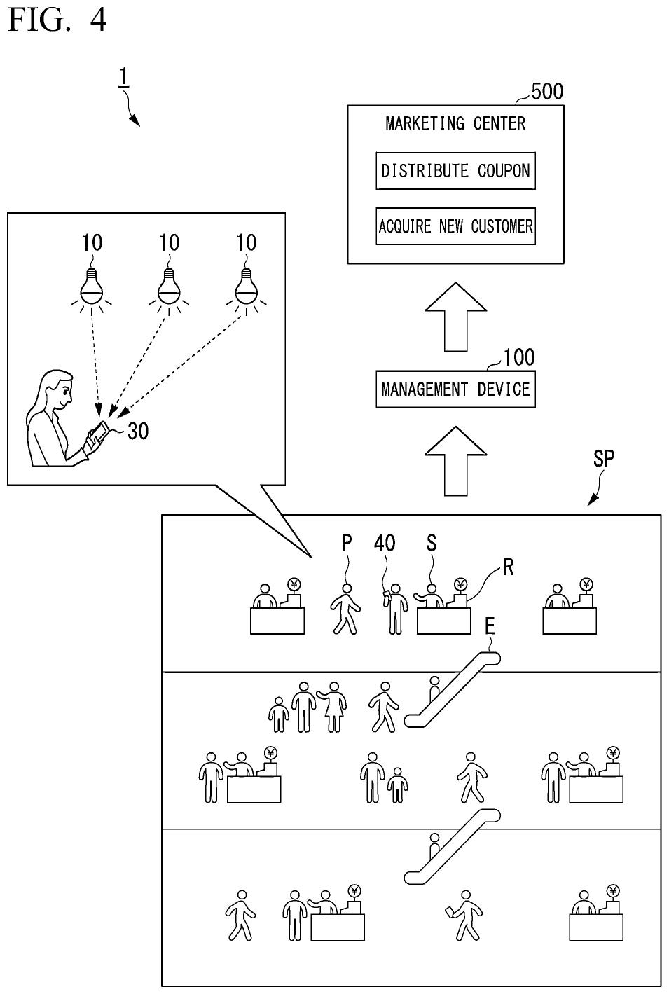

FIG. 4 is a diagram which schematically shows a commercial facility SP in which the indoor position information processing system 1 is provided. A sales area is provided on each floor in the commercial facility SP, and a customer P or a shop staff member S such as a clerk stay there. For example, an elevator E is provided between floors, and the customer P and the shop staff member S can move between the floors using the elevator. A cash register R is provided in the sales area.

A ceiling C in the commercial facility SP is provided with the plurality of pieces of illumination equipment 10, and the first transmitter 20 is embedded in some or all of the plurality of pieces of illumination equipment 10. During an illumination installation, the indoor position information processing system 1 detects a position of the illumination in the management device 100 by receiving transmission waves transmitted by the first transmitters 20 using the shop terminal 30 operated by the shop staff member S or the like.

During shop business hours, the indoor position information processing system 1 detects a position of a customer P (hereinafter referred to as a customer position) in the management device 100 by receiving transmission waves transmitted by the first transmitters using the customer terminal 40 operated by the customer P. The management device 100 detects a plurality of detected customer positions in chronological order, and transmits and provides to the marketing center 500, information on time-series customer positions in which the plurality of detected customer positions are arranged in chronological order. The marketing center 500 uses the provided information on the time-series customer positions to generate marketing information for acquiring new customers at the commercial facility SP, distributing coupons to the customer P, and the like.

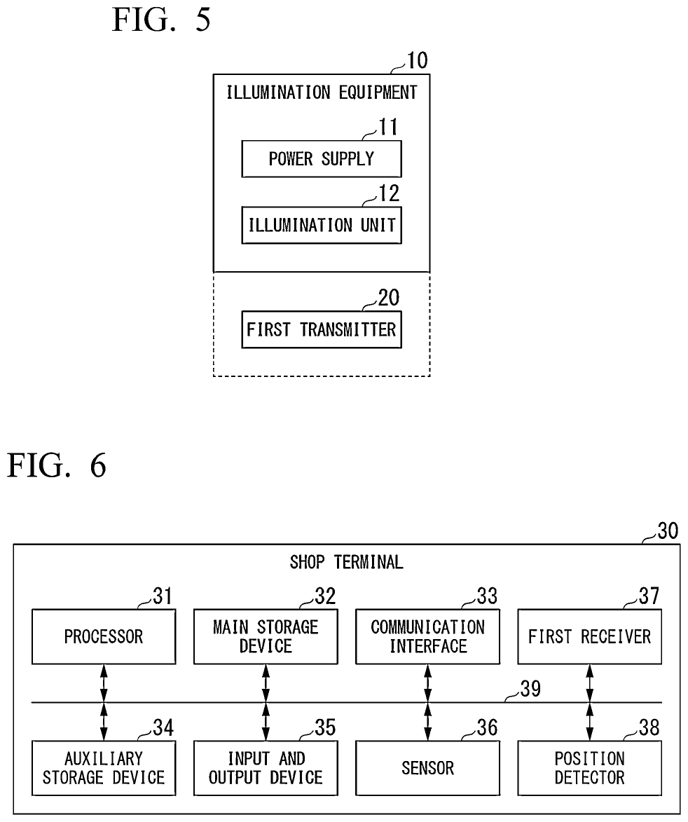

Next, a hardware configuration of each device in the indoor position information processing system 1 of the first embodiment will be described. First, a hardware configuration of the illumination equipment 10 and the first transmitter 20 will be described. FIG. 5 is a diagram which shows an example of the hardware configuration of the illumination equipment 10 and the first transmitter 20.

The illumination equipment 10 includes, for example, a power supply 11 and an illumination unit 12. The power supply 11 introduces, for example, external power and acquires power for lighting up an illumination. The illumination unit 12 includes, for example, a light emitting diode (LED) circuit, and lights up an LED using electric power supplied from the power supply 11 to illuminate the surrounding area.

The illumination equipment 10 has an embedded first transmitter 20. The first transmitter 20 transmits transmission waves used for, for example, ultra-wide band (UWB), Bluetooth (a registered trademark), Wi-Fi, near field communication (NFC), and the like. Transmission waves are radio waves that can be used to identify individuals and measure a distance. Transmission waves are an example of distance-measurement waves. The first transmitter 20 may be a transmitter that emits sound waves (ultrasonic waves).

The first transmitter 20 is connected to, for example, an LED circuit in the illumination equipment 10. The first transmitter 20 operates using the electric power supplied to the LED circuit by the power supply 11. The power supply 11 may include, for example, a power storage unit and supply stored power to the illumination unit 12. The first transmitter 20 transmits transmission waves at regular time intervals while power is being supplied by the power supply 11.

The transmission waves transmitted by the first transmitter 20 include transmission wave information. Each first transmitter 20 is assigned a unique transmitter ID. The transmission wave information included in the transmission waves transmitted by the first transmitter 20 includes transmitter identification information indicating a transmitter ID for identifying the first transmitter 20 that has transmitted the transmission waves.

The transmission wave information does not need to include transmitter identification information indicating a transmitter ID. The transmitter identification information may be acquired by the shop terminal 30 reading a two-dimensional code, such as a QR code (a registered trademark), printed on an outer surface of the first transmitter 20 or a package of the first transmitter 20, or may also be provided separately from the management device 100 or the like.

Next, a hardware configuration of the shop terminal 30 will be described. FIG. 6 is a diagram which shows an example of the hardware configuration of the shop terminal 30 of the first embodiment. The shop terminal 30 includes, for example, a processor 31, a main storage device 32, a communication interface 33, an auxiliary storage device 34, an input and output device 35, a sensor 36, a first receiver 37, a position detector 38, and a bus 39.

The processor 31 is, for example, a CPU, reads and executes a terminal control program, and realizes each function of the shop terminal 30. The terminal control program is, for example, a position information registration application that registers a position of the illumination equipment 10. The position information registration application is, for example, an application for registering the position of the illumination equipment 10 installed on the ceiling or when the illumination equipment 10 is installed on the ceiling.

In addition, the processor 31 may read and execute programs other than the terminal control program, and realize a function necessary for realizing each function of the shop terminal 30. The main storage device 32 is, for example, a RAM, and stores in advance the terminal control program and other programs that are read and executed by the processor 31.

The communication interface 33 is an interface circuit for communicating with the management device 100 and the like via the network NW and other networks. The auxiliary storage device 34 is, for example, a hard disk drive, a solid state drive, a flash memory, or a ROM.

The input and output device 35 is, for example, a touch panel display. The sensor 36 includes, for example, at least one of an angular velocity sensor and an acceleration sensor. The first receiver 37 receives the transmission wave transmitted by the first transmitter 20. When the first transmitter 20 transmits sound waves (ultrasonic waves), the first receiver 37 may be a microphone that receives the sound waves (ultrasonic waves).

The position detector 38 detects a position of the shop terminal 30. The position detector 38 is, for example, a global navigation satellite system (GNSS) device such as a global positioning system (GPS). The bus 39 connects the processor 31, the main storage device 32, the communication interface 33, the auxiliary storage device 34, the input and output device 35, the sensor 36, the first receiver 37, and the position detector 38 so that data can be transmitted or received to or from each other. The auxiliary storage device 34 stores terminal identification data indicating a unique identification code assigned to itself and a transmitter ID that identifies the first transmitter 20.

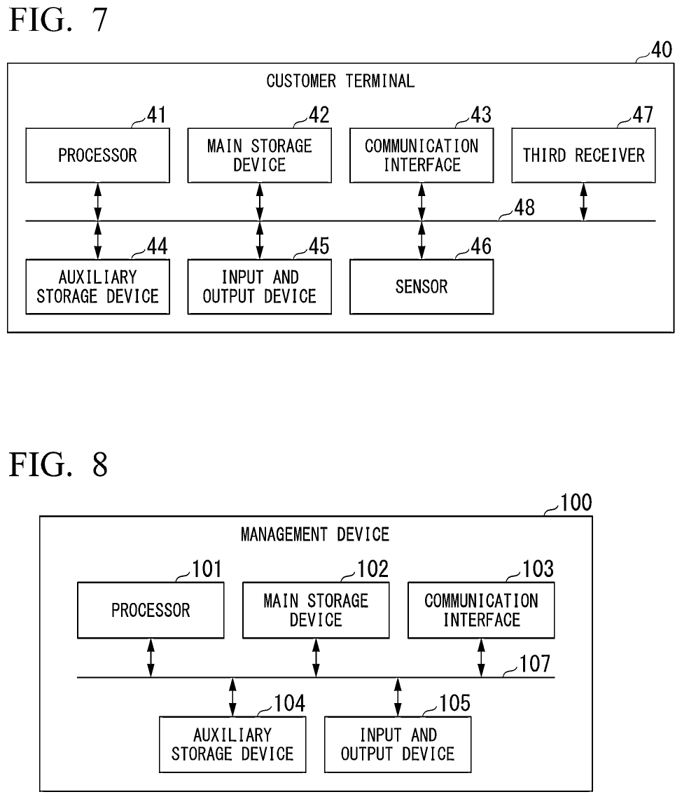

Next, the customer terminal 40 of the first embodiment will be described. FIG. 7 is a diagram which shows an example of a hardware configuration of the customer terminal 40 of the first embodiment. The customer terminal 40 includes, for example, a processor 41, a main storage device 42, a communication interface 43, an auxiliary storage device 44, an input and output device 45, a sensor 46, a third receiver 47, and a bus 49. The customer terminal 40 has the same constituents as the shop terminal 30 except that it does not include a position detector. The customer terminal 40 may be equipped with a position detector similarly to the shop terminal 30.

Next, a hardware configuration of the management device 100 of the first embodiment will be described. FIG. 8 is a diagram which shows an example of the hardware configuration of the management device 100 of the first embodiment. The management device 100 includes a processor 101, a main storage device 102, a communication interface 103, an auxiliary storage device 104, an input and output device 105, and a bus 107.

The processor 101 is, for example, a CPU, reads and executes an indoor position information processing program, and realizes each function of the management device 100. In addition, the processor 101 may read and execute programs other than the indoor position information processing program to realize functions necessary for realizing each function of the management device 100. The main storage device 102 is, for example, a RAM, and stores in advance the indoor position information processing program and other programs that are read and executed by the processor 101.

The communication interface 103 is an interface circuit for communicating with the shop terminal 30, the customer terminal 40, and the like via the network NW and other networks. The auxiliary storage device 104 is, for example, a hard disk drive, a solid state drive, a flash memory, or an ROM.

The input and output device 105 is, for example, a touch panel display. The bus 107 connects the processor 101, the main storage device 102, the communication interface 103, the auxiliary storage device 104, and the input and output device 105 so that data can be transmitted or received to or from each other. The input and output device 105 may be configured to have an input device and an output device independently.

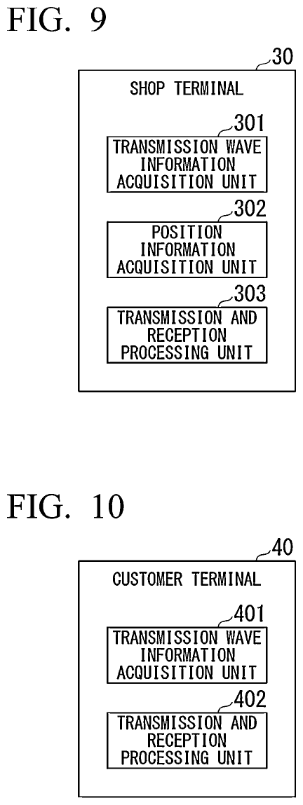

Next, a functional configuration of the indoor position information processing system 1 will be described. FIG. 9 is a diagram which shows an example of a functional configuration of the shop terminal 30 of the first embodiment. The shop terminal 30 includes, for example, a transmission wave information acquisition unit 301, a position information acquisition unit 302, and a transmission and reception processing unit 303.

The transmission wave information acquisition unit 301 acquires transmission wave information included in the transmission wave transmitted by the first transmitter 20 and received by the first receiver 37. The transmission wave information includes distance information for calculating a distance between the first transmitter 20 and the first receiver 37 (hereinafter referred to as a first distance), and transmitter identification information indicating a transmitter ID for identifying the first transmitter 20. For example, the distance information is a frequency of the transmission wave when the first transmitter 20 is a transmitter that uses UWB, and the distance information is a radio wave intensity of the transmission wave received by the first receiver 37 when the first transmitter 20 is a transmitter that uses Bluetooth (a registered trademark) or Wi-Fi.

The position information acquisition unit 302 acquires the position of the shop terminal 30 detected by the position detector 38. The transmission and reception processing unit 303 transmits to the management device 100, the distance information and the transmitter identification information acquired by the transmission wave information acquisition unit 301 and position information on the position of the shop terminal 30 acquired by the position information acquisition unit 302.

The shop terminal 30 moves along with, for example, a shop staff who carries the shop terminal 30. For example, the shop terminal 30 receives a transmission wave transmitted by the first transmitter 20 when the shop terminal 30 moves. The shop terminal 30 transmits distance information, transmitter identification information, and position information to the management device 100 every time it receives a transmission wave. For this reason, the shop terminal 30 transmits the distance information, the transmitter identification information, and the position information to the management device 100 a plurality of times. The transmission and reception processing unit 303 may transmit various types of information to the management device 100 on the basis of an elapse of a certain period of time or an operation of the shop staff member S operating the shop terminal 30.

Next, a functional configuration of the customer terminal 40 will be described. FIG. 10 is a diagram which shows an example of the functional configuration of the customer terminal 40 of the first embodiment. The customer terminal 40 includes, for example, a transmission wave information acquisition unit 401 and a transmission and reception processing unit 402. The transmission wave information acquisition unit 401, like the transmission wave information acquisition unit 301 of the shop terminal 30, each acquires transmission wave information.

The transmission and reception processing unit 402 transmits to the management device 100, distance information and transmitter identification information included in the transmission wave information acquired by the transmission wave information acquisition unit 401. The distance information herein is information for calculating the first distance. The customer terminal 40 moves along with, for example, a customer who carries the customer terminal 40. The transmission and reception processing unit 402 of the customer terminal 40, like the shop terminal 30, transmits the distance information and the transmitter identification information to the management device 100 a plurality of times. The transmission and reception processing unit 402 may transmit various types of information to the management device 100 on the basis of the elapse of a certain period of time or the operation of the shop staff member S operating the shop terminal 30.

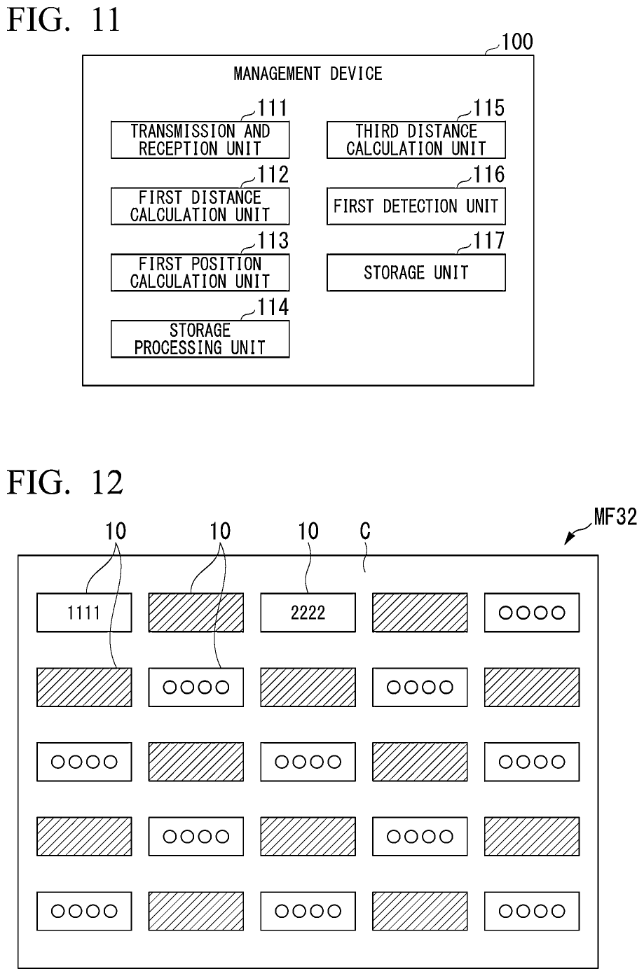

Next, a functional configuration of the management device 100 will be described. FIG. 11 is a diagram which shows an example of the functional configuration of the management device 100 of the first embodiment. The management device 100 includes, for example, a transmission and reception unit 111, a first distance calculation unit 112, a first position calculation unit 113, a storage processing unit 114, a third distance calculation unit 115, a first detection unit 116, and a storage unit 117.

The transmission and reception unit 111 receives various types of information transmitted from the shop terminal 30 and the customer terminal 40. The transmission and reception unit 111 receives a plurality of pieces of distance information, transmitter identification information, and position information transmitted by the shop terminal 30 and the customer terminal 40. The transmission and reception unit 111 receives the distance information, the transmitter identification information, and the position information transmitted by the shop terminal 30 and the customer terminal 40 every time the shop terminal 30 and the customer terminal 40 move.

The first distance calculation unit 112 calculates a distance (hereinafter referred to as a first distance) between the first transmitter 20 embedded in the illumination equipment 10 and the first receiver 37 provided in the shop terminal 30 on the basis of the distance information and the transmitter identification information transmitted by the shop terminal 30 and received by the transmission and reception unit 111. The first distance calculation unit 112 calculates the first distance for each of the plurality of first transmitters 20.

The first position calculation unit 113 calculates a position of the first transmitter 20 as the position of the illumination equipment 10 in which the first transmitter 20 is embedded (hereinafter, a first position) on the basis of the first distance calculated by the first distance calculation unit 112 and the position information received by the transmission and reception unit 111. The position information at this time is position information indicating the position of the shop terminal 30 detected by the position detector 38 when the first distance is calculated.

The first distance calculation unit 112 and the first position calculation unit 113 may be included in, for example, the shop terminal 30, instead of the management device 100. In this case, the shop terminal 30 may transmit information indicating the calculated first distance and first position to the management device 100 using the transmission and reception processing unit 303.

The plurality of pieces of illumination equipment 10 are provided indoors in the commercial facility SP. The first transmitter 20 is embedded in some or all of the plurality of pieces of illumination equipment 10. The first position calculation unit 113 calculates a first position of each of the plurality of pieces of illumination equipment 10 in which the first transmitter 20 is embedded. The first position calculation unit 113 associates a transmitter ID of the first transmitter 20 embedded in the illumination equipment 10 with the first position when the first position is calculated.

When the position of the illumination equipment 10 is calculated, the first distance calculated on the basis of transmission waves transmitted by one first transmitter 20, which are acquired by the shop terminal 30 at two or more locations, is used. For example, the position of the illumination equipment 10 is calculated on the basis of the first distance and the position of the shop terminal 30 (a position of the first receiver 37) when the shop terminal 30 is at an arbitrary position, and the first distance and the position of the shop terminal 30 (the position of the first receiver 37) when the shop terminal 30 is at another position. The first position calculation unit 113 associates the transmitter ID of the first transmitter 20 embedded in the illumination equipment 10 at this time with the first position.

The storage processing unit 114 stores and registers the first position associated with the transmitter ID in the storage unit 117. The storage unit 117 stores first positions for the plurality of pieces of illumination equipment 10. FIG. 12 is a diagram which shows the position of the illumination equipment 10 associated with a transmitter ID. In this example, a ceiling inside a room of the building M shown in FIG. 3 is visualized, and the transmitter ID of the first transmitter 20 embedded in the illumination equipment 10 installed in the ceiling is shown.

For example, the transmitter ID of the first transmitter 20 embedded in the illumination equipment 10 in the uppermost left column is “1111.” The illumination equipment 10 next to it does not have an embedded first transmitter 20, so no transmitter ID is shown. The transmitter ID of the first transmitter 20 embedded in the illumination equipment 10 next to it is “2222.” Similarly, the transmitter IDs of the first transmitters 20 embedded in other pieces of illumination equipment 10 are shown.

For example, if a ceiling blueprint showing an arrangement of the illumination equipment 10 is prepared in advance, the first position may be calculated in association with the position of the illumination equipment 10 included in the blueprint. The arrangement of the illumination equipment 10 on the ceiling may be shown in the blueprint, or may be shown in a corrected image obtained by performing keystone correction on an image of the ceiling captured indoors in the building M.

When there is no information indicating the arrangement of the illumination equipment 10 such as a blueprint, the position of the illumination equipment 10 may be calculated using the position of the shop terminal 30 detected by the position detector 38 of the shop terminal 30 as a reference position. In this case, the position of the illumination equipment 10 can be calculated on the basis of two or more positions and first distances of the shop terminal 30. In addition, when a direction of the first transmitter 20 with respect to the shop terminal 30 (hereinafter referred to as a first direction) can be detected, the first position may also be calculated on the basis of the position of the shop terminal 30, the first distance, and the first direction.

The third distance calculation unit 115 calculates a distance between the first transmitter 20 and the third receiver 47 (hereinafter referred to as the third distance) for each of the plurality of first transmitters 20 on the basis of distance information and transmitter identification information transmitted by the customer terminal 40 and received by the transmission and reception unit 111. The third distance calculation unit 115 calculates a third distance with respect to each of the plurality of pieces of illumination equipment 10 in which the first transmitter 20 is embedded.

The first detection unit 116 detects a position of the customer terminal 40 on the basis of a plurality of third distances calculated by the third distance calculation unit 115 and a plurality of first positions stored by the storage processing unit 114. The storage processing unit 114 stores and registers the position of the customer terminal 40 detected by the first detection unit 116 (hereinafter referred to as a customer terminal position) in the storage unit 117 as a position of a customer. The first detection unit 116 detects a customer terminal position as the customer position where the customer is positioned on the basis of, for example, third distances with respect to at least two first transmitters 20 and the first positions of these first transmitters 20.

The first detection unit 116 detects the position of a customer when the customer moves and is positioned at a plurality of locations. The first detection unit 116 stores and registers in the storage unit 117, time-series customer positions in which a plurality of detected customer positions are arranged in chronological order. The transmission and reception unit 111 transmits the time-series customer positions stored in the storage unit 117 to, for example, the marketing center 500, and the like.

The third distance calculation unit 115 and the first detection unit 116 may be included in, for example, the customer terminal 40, instead of the management device 100. In this case, the customer terminal 40 may transmit information indicating the calculated third distance and the customer terminal position to the management device 100 using the transmission and reception processing unit 402.

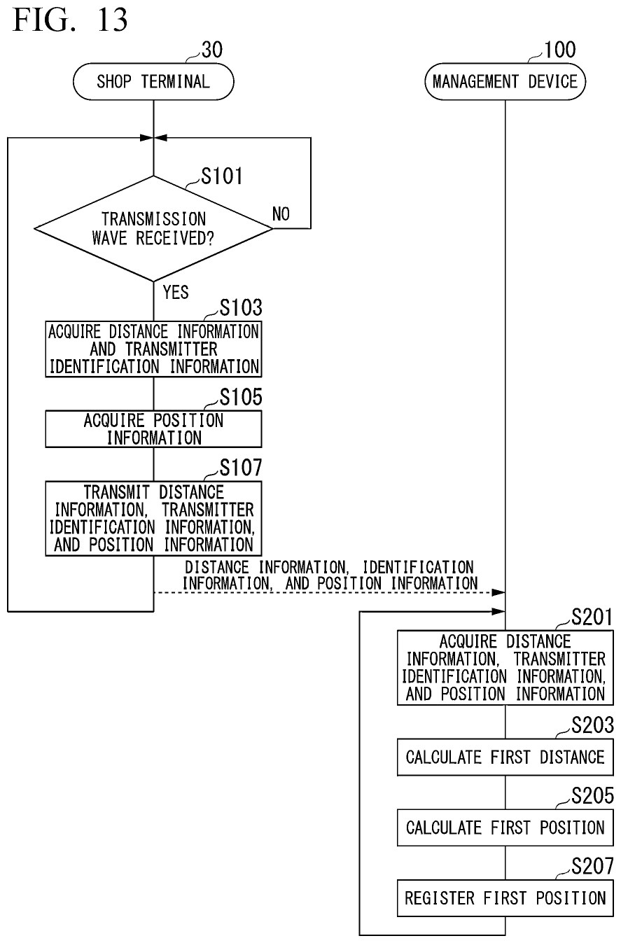

Next, processing in the indoor position information processing system 1 will be described. The indoor position information processing system 1 functions as the indoor position information storage processing system 1A during an illumination installation, and uses the shop terminal 30 together with the management device 100. The indoor position information processing system 1 functions as the indoor position information detection system 1B during shop business hours, and uses the customer terminal 40 together with the management device 100. Hereinafter, processing during an illumination installation will be described, and processing during shop business hours will be described. FIG. 13 is a sequence diagram which shows an example of processing in the indoor position information processing system 1 during an illumination installation.

First, the processing during an illumination installation will be described. In a preliminary stage of the illumination installation, in the commercial facility SP, the illumination equipment 10 is installed in a predetermined room on a predetermined floor in the building M, and the first position is calculated and stored on the basis of a transmitter ID of the first transmitter 20 installed in the illumination equipment 10.

For the calculation of the first position of the illumination equipment 10 using the shop terminal 30, an address of the building M where there is a room for calculating the first position, a floor on which this room is installed in the building M, a position of the room within the floor, and the like are registered in the management device 100 on the basis of an operation of the shop terminal 30 by the shop staff member S. The address of the building M, the floor on which this room is present, and the position of the room within the floor may also be registered by other means. For example, when a blueprint of the building M and an image in which the ceiling is captured are prepared, the address of the building and the floor of the room may be shown in information of the blueprint or the image.

In the indoor position information processing system 1, the plurality of pieces of illumination equipment 10 are sequentially installed on the ceiling C of the building M during the illumination installation. Some pieces of illumination equipment 10 have an embedded first transmitter 20 and some do not have an embedded first transmitter 20. Among the first transmitters 20 embedded in the plurality of pieces of illumination equipment 10 installed on the ceiling C, the first transmitter 20 connected to the power supply 11 emits a transmission wave at regular time intervals. The shop staff member S carries the shop terminal 30 and moves around the room, for example, approaches the illumination equipment 10, and causes the first receiver 37 to receive the transmission wave transmitted by the first transmitter 20.

The shop terminal 30 carried by the shop staff member S determines in the transmission wave information acquisition unit 301 whether the first receiver 37 has received the transmission wave transmitted by the first transmitter 20 (step S101). When it is determined that the first receiver 37 has not received the transmission wave, the transmission wave information acquisition unit 301 repeats the processing of step S101.

When it is determined that the first receiver 37 has received the transmission wave, the transmission wave information acquisition unit 301 acquires distance information and transmitter identification information based on the transmission wave on the basis of the transmission wave information received by the first receiver 37 (step S103). Subsequently, the position information acquisition unit 302 acquires the position of the shop terminal 30 detected by the position detector 38, and generates and acquires position information on the position of the shop terminal 30 (step S105).

Subsequently, the transmission and reception processing unit 303 transmits to the management device 100, the distance information and the transmitter identification information acquired by the transmission wave information acquisition unit 301 and the position information acquired by the position information acquisition unit 302 (step S107). The shop terminal 30 continues processing of step S101 to step S107 until all the pieces of illumination equipment 10 scheduled to be installed on the ceiling C are installed and all the distance information and transmitter identification information of the first transmitters 20 embedded in the plurality of pieces of illumination equipment 10 installed on the ceiling C are acquired.

The management device 100 acquires distance information, transmitter identification information, and position information through the transmission and reception unit 111 every time the shop terminal 30 transmits these pieces of information (step S201). Subsequently, the first distance calculation unit 112 calculates the first distance of the first transmitter 20 whose transmitter ID is identified according to the transmitter identification information, on the basis of the distance information and the transmitter identification information acquired by the transmission and reception unit 111 (step S203).

After the first distance calculation unit 112 calculates a plurality of first distances for a specific first transmitter 20, the first position calculation unit 113 calculates the position of the specific first transmitter 20, and calculates it as the first position of the illumination equipment 10 in which the specific first transmitter 20 is embedded (step S205). Subsequently, the storage processing unit 114 stores and registers the first position calculated by the first position calculation unit 113 in the storage unit 117 (step S207).

Subsequently, the first position calculation unit 113 determines whether or not all the first positions of the pieces of illumination equipment 10 in which the first transmitter 20 is embedded, among the plurality of pieces of illumination equipment 10 installed on the ceiling C, have been calculated (step S209). When it is determined that all the first positions of the pieces of illumination equipment 10 in which the first transmitter 20 is embedded have not been calculated, the first position calculation unit 113 returns the processing to step S201, and the management device 100 repeats the processing from step S201 to step S207.

The first position calculation unit 113 calculates the first positions of the plurality of pieces of illumination equipment 10, and the storage processing unit 114 stores and registers the plurality of first positions in the storage unit 117. The storage unit 117 stores time-series customer positions. When it is determined that the first position calculation unit 113 has calculated all the first positions of the pieces of illumination equipment 10 in which the first transmitter 20 is embedded, the management device 100 ends the processing during the illumination installation in the indoor position information processing system 1.

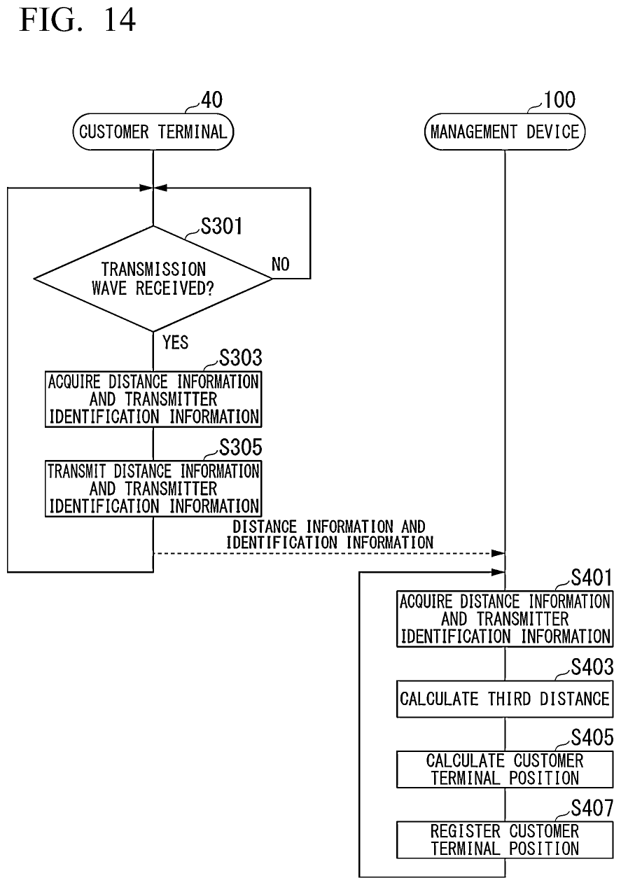

Next, processing during shop business hours will be described. FIG. 14 is a sequence diagram which shows an example of processing in the indoor position information processing system 1 during shop business hours. In the indoor position information processing system 1, the first transmitter 20 embedded in the illumination equipment 10 transmits a transmission wave at regular time intervals during shop business hours. A customer P who has visited the commercial facility SP carries the customer terminal 40 and moves within the commercial facility SP.

When the customer terminal 40 carried by the customer P approaches the illumination equipment 10, the third receiver 47 receives a transmission wave transmitted by the first transmitter 20. The customer terminal 40 determines in the transmission wave information acquisition unit 401 whether or not the third receiver 47 has received the transmission wave transmitted by the first transmitter 20 (step S301). When it is determined that the third receiver 47 has not received the transmission wave, the transmission wave information acquisition unit 401 repeats the processing of step S301.

When it is determined that the third receiver 47 has received the transmission wave, the transmission wave information acquisition unit 401 acquires distance information and transmitter identification information based on the transmission wave, on the basis of the transmission wave information received by the third receiver 47 (step S303). Subsequently, the transmission and reception processing unit 402 transmits to the management device 100, the distance information and the transmitter identification information acquired by the transmission wave information acquisition unit 301 (step S305).

The management device 100 acquires distance information and transmitter identification information using the transmission and reception unit 111 every time the customer terminal 40 transmits the distance information and the transmitter identification information (step S401). Subsequently, the third distance calculation unit 115 calculates a third distance to the first transmitter 20 whose transmitter ID is identified according to the transmitter identification information, on the basis of the distance information and the transmitter identification information acquired by the transmission and reception unit 111 (step S403).

After the third distance calculation unit 115 calculates third distances to the plurality of first transmitters 20, the first detection unit 116 detects a customer terminal position (step S405). Subsequently, the storage processing unit 114 stores and registers the customer terminal position detected by the first detection unit 116 in the storage unit 117 (step S407). After that, the first detection unit 116 returns the processing to step S401, and the management device 100 repeats the processing from step S401 to step S407.

In the indoor position information processing system 1 of the first embodiment, the first transmitter 20 is embedded in the illumination equipment 10, and the first receiver 37 is provided in the shop terminal 30. For this reason, since a distance between the moving shop terminal 30 and the illumination equipment 10 can be calculated, the position of the illumination equipment 10 can be calculated on the basis of the position of the shop terminal 30.

The indoor position information processing system 1 of the first embodiment calculates position information of the customer P by using the calculated position of the illumination equipment 10, and provides the position information of the customer to the marketing center 500. For this reason, position information marketing can be made easier to use. The position information of the customer can also be used for purposes other than the position information marketing. The position information of the customer can be used, for example, to guide the customer P to a specific shop or to guide an evacuation route in an emergency.

When a transmitter and a receiver are provided to collect the position information, if it is assumed that the receiver is used at the customer terminal 40, the transmitter will be installed at the commercial facility SP, but when transmitters are installed at many locations to accurately collect the position information, securing a power supply becomes a problem. In this regard, the first transmitter 20 is embedded in the illumination equipment 10 in the indoor position information processing system 1 of the first embodiment. For this reason, it becomes easy to secure a power supply for the first transmitter 20. Moreover, the illumination equipment 10 is widely installed within the commercial facility SP. For this reason, the first transmitters 20 can also be installed at many locations.

When the first transmitter 20 is installed in this manner, it is necessary to be able to identify the first transmitter 20 embedded in the illumination equipment 10 using a unique transmitter ID or the like. Collecting information for identifying the first transmitter 20 may take time and effort. In this regard, the transmitter ID of the first transmitter 20 is collected during an illumination installation using the shop terminal 30 in the indoor position information processing system 1 of the first embodiment. For this reason, information for identifying the first transmitter 20 can be easily acquired to acquire the position of the illumination equipment 10.

In addition, the third receiver 47 of the customer terminal 40 receives the transmission wave transmitted by the first transmitter 20 to collect position information of the customer. For this reason, the first transmitter 20 used to acquire information for identifying the position of the illumination equipment 10 can be used to collect customer position information, so that it is possible to contribute to a reduction in the number of components of the indoor position information processing system 1 as a whole.

### Second Embodiment

Next, a second embodiment will be described. In the following description, members and functions common to those in the first embodiment may be denoted by the same reference numerals in the drawings, and the description thereof may be omitted. First, an overall configuration of an indoor position information processing system 2 of the second embodiment will be described.

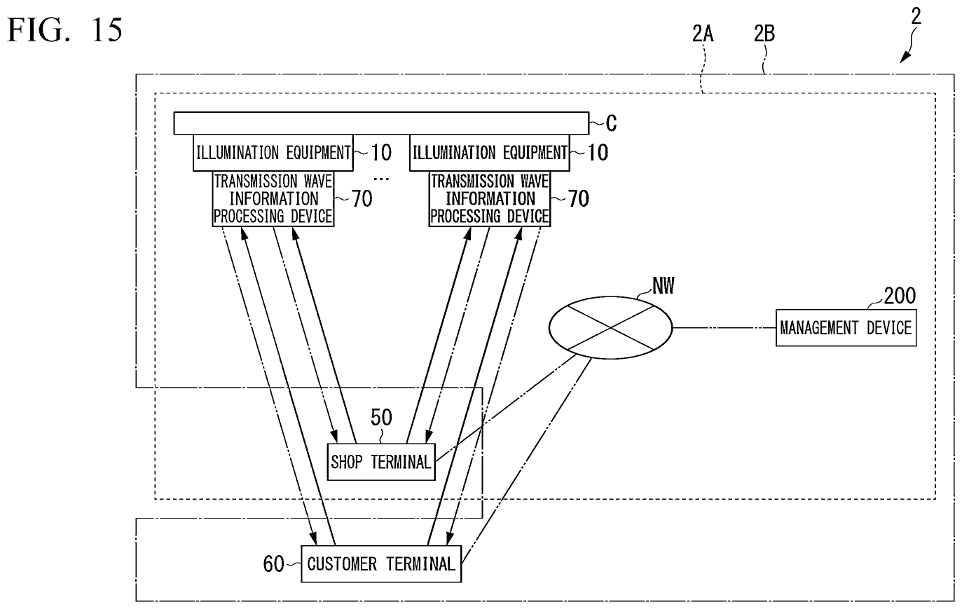

FIG. 15 is a diagram which shows an example of the indoor position information processing system 2 of the second embodiment. The indoor position information processing system 2 includes, for example, the plurality of pieces of illumination equipment 10, a shop terminal 50, a customer terminal 60, a plurality of transmission wave information processing devices 70, and a management device 200. The management device 200 is an example of a second information processing device and a fourth information processing device.

Compared to the first embodiment, the illumination equipment 10 has constituents common to those of the first embodiment, except that the illumination equipment 10 has an embedded transmission wave information processing device 70, instead of the first transmitter 20. The shop terminal 50 and the management device 100, and the customer terminal 60 and the management device 100, are connected to each other by a network NW to be able to communicate with each other.

The indoor position information processing system 2 functions as an indoor position information storage processing system 2A including the plurality of pieces of illumination equipment 10, the shop terminal 50, the transmission wave information processing device 70, and the management device 200 during an illumination installation. The indoor position information processing system 1 functions as an indoor position information detection system 2B including the plurality of pieces of illumination equipment 10, the customer terminal 60, the transmission wave information processing device 70, and the management device 200 during shop business hours.

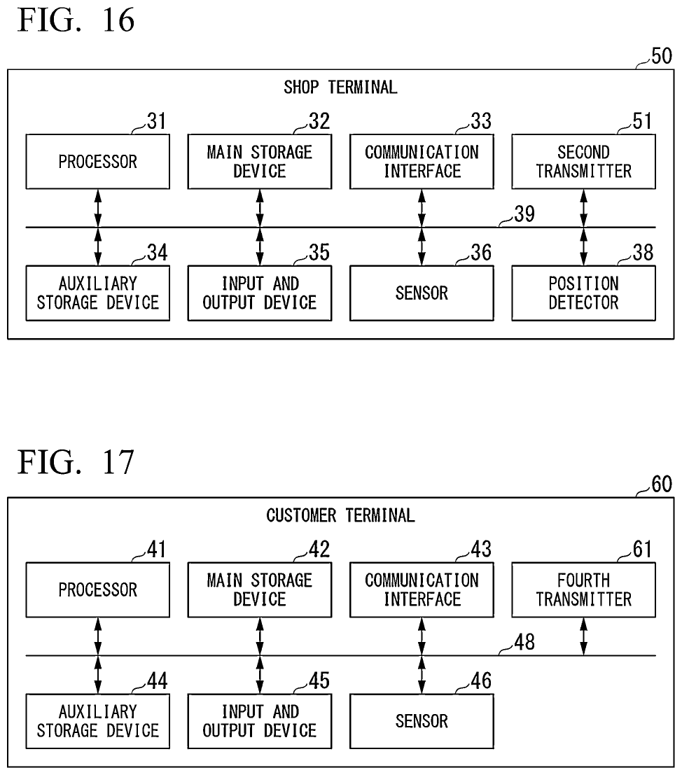

FIG. 16 is a diagram which shows an example of a hardware configuration of the shop terminal 50 of the second embodiment. The shop terminal 50 includes the processor 31, the main storage device 32, the communication interface 33, the auxiliary storage device 34, the input and output device 35, the sensor 36, and the position detector 38, similarly to the shop terminal 30 of the first embodiment.

The shop terminal 50 further includes a second transmitter 51 that transmits transmission waves. The second transmitter 51, similarly to the first transmitter 20 of the first embodiment, transmits transmission waves used for UWB, Bluetooth, Wi-Fi, NFC, or the like. The transmission wave includes transmission wave information, and the transmission wave information includes a shop terminal ID for identifying the shop terminal 50.

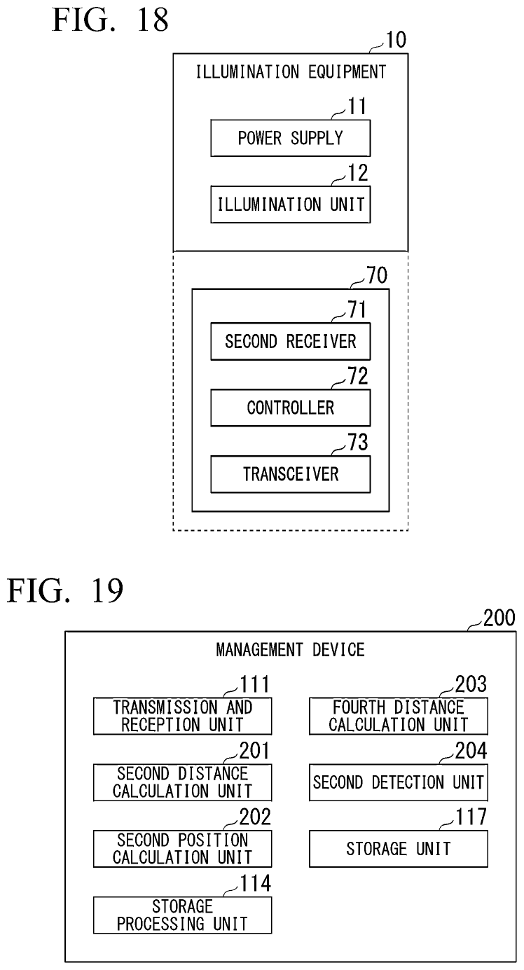

FIG. 17 is a diagram which shows an example of a hardware configuration of the customer terminal 60 of the second embodiment. The customer terminal 60 includes the processor 41, the main storage device 42, the communication interface 43, the auxiliary storage device 44, the input and output device 45, and the sensor 46, similarly to the customer terminal 40 of the first embodiment. The customer terminal 60 may include a position detector.

The customer terminal 60 further includes a fourth transmitter 61 that transmits a transmission wave. The fourth transmitter 61, similarly to the first transmitter 20 of the first embodiment, transmits a transmission wave used for the UWB, the Bluetooth, the Wi-Fi, the NFC, or the like. The transmission wave includes transmission wave information, and the transmission wave information includes a customer terminal ID for identifying the customer terminal 60.

FIG. 18 is a diagram which shows an example of a hardware configuration of the illumination equipment 10 and the transmission wave information processing device 70 of the second embodiment. The illumination equipment 10 includes the power supply 11 and the illumination unit 12, similarly to the first embodiment. The transmission wave information processing device 70 includes, for example, a second receiver 71, a controller 72, and a transceiver 73.

The second receiver 71 receives the transmission wave transmitted by the second transmitter 51 provided in the shop terminal 50 and the fourth transmitter 61 provided in the customer terminal 60. The second receiver 71 is given a receiver ID that identifies the second receiver 71. The receiver ID is included in, for example, receiver identification information.

The controller 72 acquires transmission wave information included in the transmission wave received by the second receiver 71. The transmission wave information includes distance information for calculating a distance between the second transmitter 51 and the second receiver 71 (hereinafter referred to as a second distance) and a distance between the fourth transmitter 61 and the second receiver 71 (hereinafter referred to as a fourth distance), and terminal identification information indicating a shop terminal ID and a customer terminal ID that identify the shop terminal 50 and the customer terminal 60. The distance information is the same frequency and radio wave intensity as in the first embodiment.

The transceiver 73 transmits the transmission wave information acquired by the controller 72 and receiver identification information to the shop terminal 50 including the second transmitter 51 that has transmitted a transmission wave and the customer terminal 60 including the fourth transmitter 61. The shop terminal 50 including the second transmitter 51 that has transmitted a transmission wave and the customer terminal 60 including the fourth transmitter 61 are determined on the basis of the shop terminal ID and the customer terminal ID acquired by the controller 72.

The shop terminal 50 and the customer terminal 60 receive transmission wave information and the receiver information transmitted by the transmission wave information processing device 70. The shop terminal 50 and the customer terminal 60 acquire distance information and terminal identification information included in the transmission wave information. The shop terminal 50 and the customer terminal 60 each acquire a plurality of pieces of distance information and terminal identification information at the same time for each of the plurality of second receivers 71. The shop terminal 50 and the customer terminal 60 transmit to the management device 200, the acquired distance information and terminal identification information at the same time for each of the plurality of second receivers 71, together with position information on positions of the shop terminal 50 and the customer terminal 60.

FIG. 19 is a diagram which shows an example of a functional configuration of the management device 200 of the second embodiment. The management device 200 includes, for example, a transmission and reception unit 111, a second distance calculation unit 201, a second position calculation unit 202, a storage processing unit 114, a fourth distance calculation unit 203, a second detection unit 204, and a storage unit 117. Configurations of the transmission and reception unit 111 and the storage unit 117 are similar to the configurations of the management device 100 of the first embodiment.

The second distance calculation unit 201 calculates a second distance on the basis of distance information and receiver identification information transmitted by the shop terminal 50 and received by the transmission and reception unit 111. The second distance calculation unit 201 calculates the second distance for each of the plurality of second receivers 71.

The second position calculation unit 202 calculates a position of the second receiver 71 on the basis of the second distance calculated by the second distance calculation unit 201 and the position information received by the transmission and reception unit 111 as the position of the illumination equipment 10 in which the second receiver 71 is embedded (hereinafter referred to as a second position). The position information at this time is position information indicating the position of the shop terminal 30 detected by the position detector 38 when the second distance is calculated. The storage processing unit 114 stores and registers the second position associated with a transmitter ID in the storage unit 117.

The fourth distance calculation unit 203 calculates a fourth distance for each of the plurality of second receivers 71 on the basis of the distance information and the receiver identification information transmitted by the customer terminal 60 and received by the transmission and reception unit 111. The fourth distance calculation unit 203 calculates a fourth distance to each of the plurality of pieces of illumination equipment 10 in which the second receiver 71 is embedded.

The second detection unit 204 detects a customer terminal position on the basis of the plurality of fourth distances calculated by the fourth distance calculation unit 203 and the plurality of second positions stored in the storage unit 117 by the storage processing unit 114. The storage processing unit 114 stores and registers the customer terminal position detected by the second detection unit 204 in the storage unit 117 as the position of a customer. The second detection unit 204 detects a customer terminal position as a customer position where the customer is positioned, on the basis of, for example, fourth distances to at least two pieces of illumination equipment 10 and second positions of these pieces of illumination equipment 10.

The indoor position information processing system 2 of the second embodiment has the same effects as the indoor position information processing system 1 of the first embodiment. Further, in the indoor position information processing system 2 of the second embodiment, the second transmitter 51 is provided in the shop terminal 50, the fourth transmitter 61 is provided in the customer terminal 60, and the second receiver 71 is embedded in the illumination equipment 10. In this manner, mounting positions of a transmitter and a receiver that measure a distance between a terminal and an illumination equipment can be diversified.

### Third Embodiment

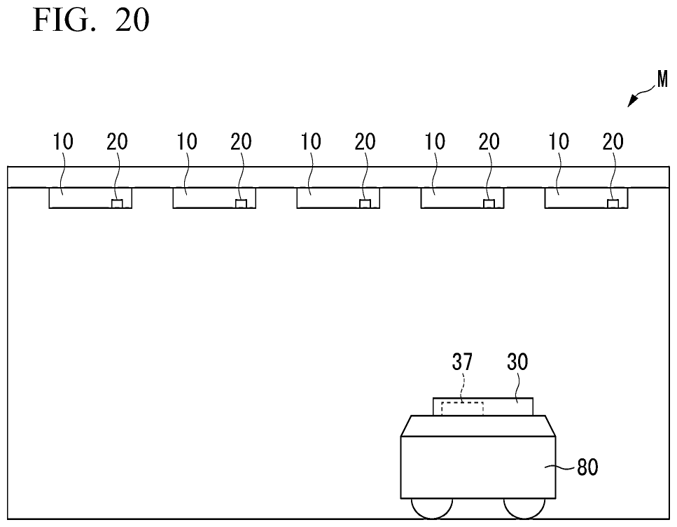

Next, a third embodiment will be described. FIG. 20 is a cross-sectional view of an interior of the building M in which a first mobile object 80 travels. The building M is a commercial facility, and a first autonomous mobile object (hereinafter referred to as a first mobile object) 80 that moves while patrolling indoors travels in the building M. The first mobile object 80 is equipped with the shop terminal 30 that includes the first receiver 37. Other points have the same configuration as the first embodiment.

An indoor position information processing system of the third embodiment has the same effects as the indoor position information processing system 1 of the first embodiment. Moreover, the first mobile object 80 is equipped with the shop terminal 30 in the indoor position information processing system 1 of the third embodiment. For this reason, it is possible to register the first position without the shop staff member S moving within the building M.

The registration of the first position may be executed at a time other than during an illumination installation. For example, the registration of the first position may be executed at a time of replacing the illumination equipment 10 or during a regular inspection. When the first position is registered at the time of replacing the illumination equipment 10 or during a regular inspection, the first mobile object 80 is equipped with the shop terminal 30 to collect transmission wave information, and the like, thereby reducing the time and effort of the shop staff or the like.

In the third embodiment, the shop terminal 30 is installed in the first mobile object, but the customer terminal 40 may also be installed in a mobile object (hereinafter referred to as a second mobile object) that moves within the building M. In this case, the customer P who carries the customer terminal 40 may board the second mobile object together with the customer terminal 40. The second mobile object may be provided with a holder for holding the customer terminal 40 or the like.

In each of the embodiments described above, the electric power apparatus provided in the building M is the illumination equipment 10, but the electric power apparatus may be other equipment that receives power from a power source. For example, it may be a sensor, an air conditioner, a speaker, or an outlet. The sensor may be a sensor that detects indoor smoke or a sensor that detects heat. These electric power apparatuses may be exposed from the ceiling or installed behind the ceiling.

An indoor position information storage processing system of an embodiment includes: an electric power apparatus provided in a building; a first transmitter attached to the electric power apparatus and configured to transmit distance-measurement waves; a first receiver configured to receive the distance-measurement waves transmitted by the first transmitter; a position detector configured to detect a position of the first receiver; and a first information processing device configured to process information based on the distance-measurement waves and the position of the first receiver. The first information processing device includes: a first distance calculation unit configured to calculate a distance between the first transmitter and the first receiver on the basis of the distance-measurement waves received by the first receiver; a first position calculation unit configured to calculate a position of the first transmitter on the basis of the calculated distance and the position of the first receiver; and a first storage processing unit configured to store the calculated position of the first transmitter in a storage unit as a position of the electric power apparatus. Thereby, it is possible to make position information marketing easier to use.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Notes

The application reserves the right to include in the claim section at any appropriate time, systems, apparatuses, devices, methods, and storage mediums according to the following notes and their equivalents.

Note 1. An indoor position information storage processing system comprising: an electric power apparatus provided in a building;
a first transmitter attached to the electric power apparatus and configured to transmit distance-measurement waves;
a first receiver configured to receive the distance-measurement waves transmitted by the first transmitter;
a position detector configured to detect a position of the first receiver; and
a first information processing device configured to process information based on the distance-measurement waves and the position of the first receiver,
wherein the first information processing device comprises:
a first distance calculation unit configured to calculate a distance between the first transmitter and the first receiver on the basis of the distance-measurement waves received by the first receiver;
a first position calculation unit configured to calculate a position of the first transmitter on the basis of the calculated distance and the position of the first receiver; and
a first storage processing unit configured to store the calculated position of the first transmitter in a storage unit as a position of the electric power apparatus.

Note 2. The indoor position information storage processing system according to note 1, further comprising:
a first mobile object configured to move within the building,
wherein the first receiver is mounted on the first mobile object.

Note 3. An indoor position information storage processing system comprising:
an electric power apparatus provided in a building;
a second transmitter configured to transmit distance-measurement waves;
a second receiver attached to the electric power apparatus and configured to receive the distance-measurement waves transmitted by the second transmitter;
a position detector configured to detect a position of the second transmitter; and
a second information processing device configured to process information based on the distance-measurement waves and the position of the second transmitter,
wherein the second information processing device comprises:
a second distance calculation unit configured to calculate a distance between the second transmitter and the second receiver on the basis of the distance-measurement waves received by the second receiver;
a second position calculation unit configured to calculate a position of the second receiver on the basis of the calculated distance and the position of the second transmitter; and
a storage processing unit configured to store the calculated position of the second receiver in a storage unit as a position of the electric power apparatus.

Note 4. The indoor position information storage processing system according to note 3, further comprising:
a second mobile object configured to move within the building,
wherein the second transmitter is mounted on the second mobile object.

Note 5. An indoor position information detection system comprising:
the indoor position information storage processing system according to note 1 or 2; and
a third information processing device configured to process information based on the position of the electric power apparatus stored by the first storage processing unit,
wherein the third information processing device comprises:
a third distance calculation unit configured to calculate a distance between the first transmitter and a third receiver on the basis of the distance-measurement waves transmitted by the first transmitter and received by the third receiver; and
a first detection unit configured to detect a position of the third receiver on the basis of the distance calculated by the third distance calculation unit and the position of the electric power apparatus.

Note 6. An indoor position information detection system comprising:
the indoor position information storage processing system according to note 3 or 4; and
a fourth information processing device configured to process information based on the position of the electric power apparatus stored by the storage processing unit,
wherein the fourth information processing device comprises:
a fourth distance calculation unit configured to calculate a distance between a fourth transmitter and the second receiver on the basis of distance-measurement waves transmitted by the fourth transmitter configured to transmit the distance-measurement waves and received by the second receiver; and
a second detection unit configured to detect a position of the fourth transmitter on the basis of the distance calculated by the fourth distance calculation unit and the position of the electric power apparatus.

Note 7. The indoor position information detection system according to note 5 or 6,
wherein the electric power apparatus is provided on a ceiling of the building.

Note 8. The indoor position information detection system according to note 7,
wherein the electric power apparatus is provided to be exposed from the ceiling.

Note 9. The indoor position information detection system according to any one of notes 5 to 8,
wherein the electric power apparatus includes at least one of illumination equipment, a sensor, an air conditioner, a speaker, and an outlet.

Note 10. The indoor position information detection system according to any one of notes 5 to 9, further comprising:
a plurality of electric power apparatuses including the electric power apparatus which are provided in the building.

Note 11. An electric power apparatus which is used in the indoor position information detection system according to note 5 and to which the first transmitter is attached.

Note 12.An electric power apparatus which is used in the indoor position information detection system according to note 6, and to which the second receiver is attached.

Note 13.An indoor position information processing device comprising:
a first distance calculation unit configured to calculate a distance between a first transmitter and a first receiver on the basis of distance-measurement waves that are transmitted by the first transmitter attached to an electric power apparatus provided in a building and received by the first receiver;
a first position calculation unit configured to calculate a position of the first transmitter on the basis of the calculated distance and a position of the first receiver; and
a first storage processing unit configured to store the calculated position of the first transmitter in a storage unit as a position of the electric power apparatus.

Note 14.An indoor position information processing device comprising:
a second distance calculation unit configured to calculate a distance between a second transmitter and a second receiver on the basis of distance-measurement waves that are transmitted by the second transmitter and received by the second receiver attached to an electric power apparatus provided in a building;
a second position calculation unit configured to calculate a position of the second receiver on the basis of the calculated distance and a position of the second transmitter; and
a storage processing unit configured to store the calculated position of the second receiver in a storage unit as a position of the electric power apparatus.

Note 15. The indoor position information processing device according to note 13, further comprising:
a third distance calculation unit configured to calculate a distance between the first transmitter and a third receiver on the basis of the distance-measurement waves that are transmitted by the first transmitter and received by the third receiver; and
a first detection unit configured to detect a position of the third receiver on the basis of the distance calculated by the third distance calculation unit and the position of the electric power apparatus.

Note 16. The indoor position information processing device according to note 14, further comprising:
a fourth distance calculation unit configured to calculate a distance between a fourth transmitter and the second receiver on the basis of distance-measurement waves that are transmitted by the fourth transmitter configured to transmit the distance-measurement waves and received by the second receiver; and
a second detection unit configured to detect a position of the fourth transmitter on the basis of the distance calculated by the fourth distance calculation unit and the position of the electric power apparatus.

Note 17.An indoor position information processing method performed by a computer of an indoor position information processing device, the indoor position information processing method comprising:
calculating a distance between a first transmitter and a first receiver on the basis of distance-measurement waves that are transmitted by the first transmitter attached to an electric power apparatus provided in a building and received by the first receiver;
calculating a position of the first transmitter on the basis of the calculated distance and a position of the first receiver; and
storing the calculated position of the first transmitter in a storage unit as a position of the electric power apparatus.

Note 18.An indoor position information processing method performed by a computer of an indoor position information processing device, the indoor position information processing method comprising:
calculating a distance between a second transmitter and a second receiver on the basis of distance-measurement waves that are transmitted by the second transmitter and received by the second receiver attached to an electric power apparatus provided in a building;
calculating a position of the second receiver on the basis of the calculated distance and a position of the second transmitter; and
storing the calculated position of the second receiver in a storage unit as a position of the electric power apparatus.

Note 19.An indoor position information processing method performed by a computer of an indoor position information processing device, the indoor position information processing method comprising:
calculating a distance between a first transmitter and a third receiver on the basis of distance-measurement waves that are transmitted by the first transmitter attached to an electric power apparatus provided in a building and received by the third receiver; and
detecting a position of the third receiver on the basis of the calculated distance between the first transmitter and the third receiver and the position of the electric power apparatus stored by the indoor position information processing device according to note 16.

Note 20.An indoor position information processing method performed by a computer of an indoor position information processing device, the indoor position information processing method comprising:
calculating a distance between a fourth transmitter and a second receiver on the basis of distance-measurement waves that are transmitted by the fourth transmitter and received by the second receiver attached to an electric power apparatus provided in a building; and
detecting a position of the fourth transmitter on the basis of the calculated distance between the fourth transmitter and the second receiver and the position of the electric power apparatus stored by the indoor position information processing method according to note 18.

Note 21.A non-transitory computer-readable storage medium storing a program which causes a computer of an indoor position information processing device to:
calculate a distance between a first transmitter and a first receiver on the basis of distance-measurement waves that are transmitted by the first transmitter attached to an electric power apparatus provided in a building and received by the first receiver;
calculate a position of the first transmitter on the basis of the calculated distance and a position of the first receiver; and
store the calculated position of the first transmitter in a storage unit as a position of the electric power apparatus.

Note 22.A non-transitory computer-readable storage medium storing a program which causes a computer of an indoor position information processing device to:
calculate a distance between a second transmitter and a second receiver on the basis of distance-measurement waves that are transmitted by the second transmitter and received by the second receiver attached to an electric power apparatus provided in a building;
calculate a position of the second receiver on the basis of the calculated distance and a position of the second transmitter; and
store the calculated position of the second receiver in a storage unit as a position of the electric power apparatus;
Note 23.A non-transitory computer-readable storage medium storing a program which causes a computer of an indoor position information processing device to:
calculate a distance between a first transmitter and a third receiver on the basis of distance-measurement waves that are transmitted by the first transmitter attached to an electric power apparatus provided in a building and received by the third receiver; and
detect a position of the third receiver on the basis of the calculated distance between the first transmitter and the third receiver and the position of the electric power apparatus stored by the indoor position information processing device according to note 16.

Note 24.A non-transitory computer-readable storage medium storing a program which causes a computer of an indoor position information processing device to:
calculate a distance between a fourth transmitter and a second receiver on the basis of distance-measurement waves that are transmitted by the fourth transmitter and received by the second receiver attached to an electric power apparatus provided in a building; and
detect a position of the fourth transmitter on the basis of the calculated distance between the fourth transmitter and the second receiver and the position of the electric power apparatus stored by the indoor position information processing method according to note 18.

What is claimed is:

1. An indoor position information storage processing system comprising:
an electric power apparatus provided in a building;
a first transmitter configured to transmit distance-measurement waves;
a first receiver attached to the electric power apparatus and configured to receive the distance-measurement waves transmitted by the first transmitter;
a position detector configured to detect a position of the first transmitter; and
a first information processing device configured to process information based on the distance-measurement waves and the position of the first transmitter,
wherein the first information processing device comprises:
a first distance calculation unit configured to calculate a distance between the first transmitter and the first receiver on the basis of the distance-measurement waves received by the first receiver;
a first position calculation unit configured to calculate a position of the first receiver on the basis of the calculated distance and the position of the first transmitter; and
a storage processing unit configured to store the calculated position of the first receiver in a storage unit as a position of the electric power apparatus.

2. The indoor position information storage processing system according to claim 1, further comprising:
a first mobile object configured to move within the building,
wherein the first transmitter is mounted on the first mobile object.

3. An indoor position information detection system comprising:
the indoor position information storage processing system according to claim 1; and
a second information processing device configured to process information based on the position of the electric power apparatus stored by the storage processing unit,
wherein the second information processing device comprises:
a second distance calculation unit configured to calculate a distance between a second transmitter and the first receiver on the basis of distance-measurement waves transmitted by the second transmitter configured to transmit the distance-measurement waves and received by the first receiver; and
a first detection unit configured to detect a position of the second transmitter on the basis of the distance calculated by the second distance calculation unit and the position of the electric power apparatus.

4. The indoor position information detection system according to claim 3,
wherein the electric power apparatus is provided on a ceiling of the building.

5. The indoor position information detection system according to claim 4,
wherein the electric power apparatus is provided to be exposed from the ceiling.

6. The indoor position information detection system according to claim 3,
wherein the electric power apparatus includes at least one of illumination equipment, a sensor, an air conditioner, a speaker, and an outlet.

7. The indoor position information detection system according to claim 3, further comprising:
a plurality of electric power apparatuses including the electric power apparatus which are provided in the building.

8. An electric power apparatus which is used in the indoor position information detection system according to claim 3, and to which the first receiver is attached.

9. An indoor position information processing device comprising:
a first distance calculation unit configured to calculate a distance between a first transmitter and a first receiver on the basis of distance-measurement waves that are transmitted by the first transmitter and received by the first receiver attached to an electric power apparatus provided in a building;
a first position calculation unit configured to calculate a position of the first receiver on the basis of the calculated distance and a position of the first transmitter; and
a storage processing unit configured to store the calculated position of the first receiver in a storage unit as a position of the electric power apparatus.

10. The indoor position information processing device according to claim 9, further comprising:
a second distance calculation unit configured to calculate a distance between a second transmitter and the first receiver on the basis of distance-measurement waves that are transmitted by the second transmitter configured to transmit the distance-measurement waves and received by the first receiver; and
a first detection unit configured to detect a position of the second transmitter on the basis of the distance calculated by the second distance calculation unit and the position of the electric power apparatus.

11. An indoor position information processing method performed by a computer of an indoor position information processing device, the indoor position information processing method comprising:
calculating a distance between a first transmitter and a first receiver on the basis of distance-measurement waves that are transmitted by the first transmitter and received by the first receiver attached to an electric power apparatus provided in a building;
calculating a position of the first receiver on the basis of the calculated distance and a position of the first transmitter; and
storing the calculated position of the first receiver in a storage unit as a position of the electric power apparatus.

12. The indoor position information processing method according to claim 11, further comprising:
calculating a distance between a second transmitter and the first receiver on the basis of distance-measurement waves that are transmitted by the second transmitter and received by the first receiver; and
detecting a position of the second transmitter on the basis of the calculated distance between the second transmitter and the first receiver and the position of the electric power apparatus.
